(19) United States
(12) Patent Application Publication
(10) Pub. No.: US 2005/0185800 A1
(43) Pub. Date: Aug. 25, 2005

(54) Parametric sound system with lower sideband

(75) Inventor: James J. Croft III, Poway, CA (US)

Correspondence Address: Attention Steve M. Perry;THORPE NORTH & WESTERN, LLP, P.O. Box 1219, Sandy, UT, 84091-1219, US

(73) Assignee: American Technology Corporation

(21) Appl. No.: 11/039,636

(22) Filed: Jan. 20, 2005

Related U.S. Application Data
(63) Continuation-in-part of application No. 09/384,084, filed on Aug. 26, 1999, now Pat. No. 6,584,205.
(63) Continuation-in-part of application No. 10/393,893, filed on Mar. 21, 2003.
(63) Continuation-in-part of application No. 09/430,801, filed on Oct. 29, 1999, now Pat. No. 6,850,623.
(60) Provisional application No. 60/538,013, filed on Jan. 20, 2004.

(51) Int. Cl. H04B 3/00; H04B 5/00

(52) U.S. Cl. 381/77; 381/79

(57) ABSTRACT

This invention provides a parametric loudspeaker system, with a carrier frequency generator to produce a carrier frequency. A modulator receives an audio signal and modulates it onto the carrier frequency, producing a modulated signal. This modulation creates at least one sideband signal that is divergent from the carrier frequency by the frequency value of the audio signal. Additionally, the sideband signal is created such that its frequency value is lower than the frequency of the carrier.

This application claims priority to and is a continuation-in-part of U.S. patent application Ser. No. 09/384,084 filed on Aug. 26, 2003, now registered U.S. Pat. No. 6,584,205, U.S. patent application Ser. No. 10/393,893 filed on Mar. 21, 2003, U.S. patent application Ser. No. 09/430,801 filed on Oct. 29, 1999, and U.S. Provisional Application No. 60/538,013 filed on Jan. 20, 2004.

### FIELD OF THE INVENTION

This invention relates to parametric loudspeakers for generating audible output.

### BACKGROUND

A parametric array in air results from the introduction of sufficiently intense, audio modulated ultrasonic signals into an air column. Self demodulation, or down-conversion, occurs along the air column resulting in an audible acoustic signal. This process occurs because of the known physical principle that when two sound waves with different frequencies are radiated simultaneously in the same medium, a modulated waveform including the sum and difference of the two frequencies is produced by the non-linear interaction (parametric interaction) of the two sound waves. When the two original sound waves are ultrasonic waves and the difference between them is selected to be an audio frequency, an audible sound is generated by the parametric interaction.

An early use of this relationship for parametric loudspeakers in air was a modulator design for parametric loudspeakers in 1985. This early system included the application of a square root function to the modulation envelope, thus compensating for the natural squaring function of the air that distorts the envelope of the emitted modulated sideband signal. In a typical application, the desired signal is amplitude modulated (AM) on an ultrasonic carrier of 30 kHz to 50 kHz, then amplified, and applied to an ultrasonic transducer. If the ultrasonic intensity of the output is of sufficient amplitude, the air column will perform a demodulation or down-conversion over some length (the length depends, in part, on the carrier frequency and column shape). The prior art, such as U.S. Pat. No. 4,823,908 to Tanaka, et al., teaches that one modulation scheme to achieve parametric audio output from an ultrasonic emission uses a signal comprising a carrier frequency with double sideband (DSB) frequencies. The DSBs are spaced on either side of the carrier frequency by the frequency sum and difference corresponding to the audio frequencies modulating the ultrasonic carrier.

Ideally, these double sideband systems use sidebands above and below the carrier frequency that are symmetrical. If the frequency response of the transducer is not generally flat over at least a 40 kHz range, the upper side band (USB) and the lower sideband (LSB) will not be symmetrical, and this makes distortion reduction processing difficult. In order to design a transducer with a flat frequency response or frequency symmetry, the equalization can utilize corrective factors that are linear with frequency rather than logarithmic. This situation is difficult to realize, so even a transducer with a smooth frequency response peak will not be linearly symmetrical above and below the resonance frequency of the transducer or carrier frequency. In other words, even transducers with relatively flat or smooth response curves are not really flat. Moreover, flat response transducer systems are generally too low in efficiency to generate desired output and parametric efficiency.

Distortion is a further consideration that can impact the output of parametric loudspeaker systems. Those skilled in the art have shown that applying a square root function to the DSB signal in a parametric system can theoretically produce a low distortion system but at the cost of infinite system and transducer bandwidth. It is not practical to produce a device that has an infinite bandwidth capability. Further, the implementation of any significant bandwidth means that the inaudible ultrasonic primary frequencies can extend down into the audible range on the lower sideband and cause new distortion which may be as bad as the distortion eliminated by the square root pre-processing system. Therefore, the theoretically ideal square rooted DSB system cannot be fully realized with prior art approaches.

Another problem inherent to parametric loudspeaker systems is that as the frequency and/or intensity of the ultrasonic carrier is increased to allow room in the inaudible range for the lower sidebands and to achieve reasonable conversion levels in the audible range, the air can be driven to saturation. The level at which saturation problems occur is reduced 6 dB for every octave the carrier frequency is increased. In other words, the power threshold at which saturation appears, decreases as the frequency increases. DSB signal systems used with parametric arrays are preferably at least the bandwidth of the program signal above any audible frequency (assuming a 20 kHz bandwidth) and even more if the distortion reducing square root function is used, which also demands an infinite bandwidth. This range forces the carrier frequency up quite high, and the USB portion of the DSB signal even higher. As a result, the saturation limit is easily reached and the overall efficiency of the system suffers.

These excessive and undesirable types of distortion affect the practical or commercial use of the uncompensated parametric arrays or even square-rooted compensation schemes in high fidelity applications. Accordingly, it would be an improvement over the state of the art to provide a system and method for transmitting audio signals in an ultrasonic carrier that would result in lowered distortion for a parametric loudspeaker system.

### SUMMARY OF THE INVENTION

This invention provides a parametric loudspeaker system with a carrier frequency generator to produce a carrier frequency. A modulator receives an audio signal and modulates the audio signal onto the carrier frequency to produce a modulated signal. This modulation creates at least one sideband signal that is divergent from the carrier frequency by the frequency value of the audio signal. Additionally, the sideband signal is created such that its frequency value is lower than the frequency of the carrier.

### BRIEF DESCRIPTION OF THE DRAWINGS

FIG. 1 is chart illustrating that emitters are not generally used in the range of frequencies below resonance due to the fact that they tend to fall in efficiency as frequency decreases;

FIG. 2 is an additional chart illustrating that emitters are not generally used in the range of frequencies below resonance due to the fact that they tend to fall in efficiency as frequency decreases;

FIG. 3 is a chart depicting a flat frequency response below resonance;

FIG. 4 is a chart depicting a frequency response that falls at 12 db per octave;

FIGS. 5a and 5b illustrate the filtering of an inverted signal; and

FIG. 6 illustrates a block diagram of an embodiment of the system where the input side of the parametric loudspeaker system accepts a line-level signal from an analog or digital audio source.

### DETAILED DESCRIPTION

Reference will now be made to the drawings in which the various elements of the present invention will be given numerical designations and in which the invention will be discussed so as to enable one skilled in the art to make and use the invention. It is to be understood that the following description is only exemplary of certain embodiments of the present invention, and should not be viewed as narrowing the claims which follow.

The present invention is a system and method for providing a parametric loudspeaker system with greater output for a parametric array with significantly less distortion than with previous systems. This is realized in part by the attenuation of energy at frequencies below the carrier frequency that may approach the audio range and cause distortion of the program material. In the present system, an incoming audio signal is modulated onto a higher ultrasonic carrier frequency to create a modulated signal. This modulated signal is then passed through an emitter into an air column and demodulation occurs. The modulated signal is filtered such that only the lower side band (LSB) signal is present with the carrier frequency.

Single sideband parametric loudspeaker systems have previously used upper side band (USB) or double side band (DSB) signals. Unfortunately, using either of these systems has created saturation and output problems. More specifically, as the frequency and/or intensity of the ultrasonic carrier is increased to allow room for the LSB signal between the carrier and the audible range, and to allow for reasonable conversion levels in the audible range, the air can be driven to saturation. This means that the fundamental ultrasonic frequency is limited as energy is robbed from it to supply the sidebands. The threshold level at which saturation problems arise is reduced 6 dB for every octave the carrier frequency is increased. In other words, the power threshold at which saturation tends to appear, decreases as the frequency increases. This means that systems utilizing LSBs have generally had carrier frequencies at least the bandwidth of the signal above any audible frequencies. Some parametric systems have removed the LSBs in order to avoid distortion in the audible range. In reality, eliminating the LSBs does not generally allow the carrier frequency to be decreased as much as may be desired because the carrier frequency must be kept farther away from the audible frequencies near 20 kHz due to the carrier frequency's high energy requirements.

The present invention uses primarily LSBs while minimizing USBs. Thus, the intensity of the carrier can be increased due to the absence of any USB energy that would cause saturation problems.

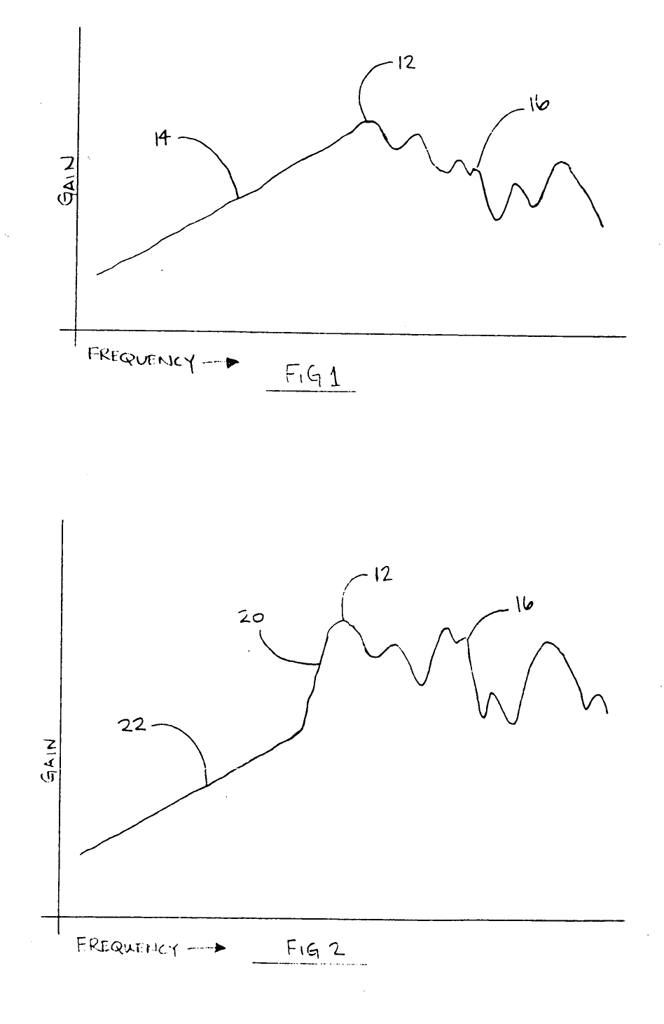

Another advantage of using LSB signals in a parametric system relates to the design of ultrasonic emitters. As shown in FIGS. 1 and 2, emitters are not generally used in the range of frequencies below resonance 12 due to the fact that they tend to fall in efficiency as frequency decreases. In this range they operate in their stiffness mode, and for a critically damped system (FIG. 1) the high pass characteristic or performance roll-off is consistently 12 dB per octave 14. For under-damped systems (FIG. 2), with much greater efficiency at the resonant frequency, the high pass characteristic or roll-off is greater than 12 dB per octave 20 down to a given frequency, after which it shifts back to 12 dB per octave decline 22. Above resonance 12, the frequency response of most piezoelectric transducers is erratic 16 for both the critically damped and under-damped systems. In the case of the PVDF emitters that use positive or negative pressure for film distention, greater pressure differentials can cause greater frequency response anomalies.

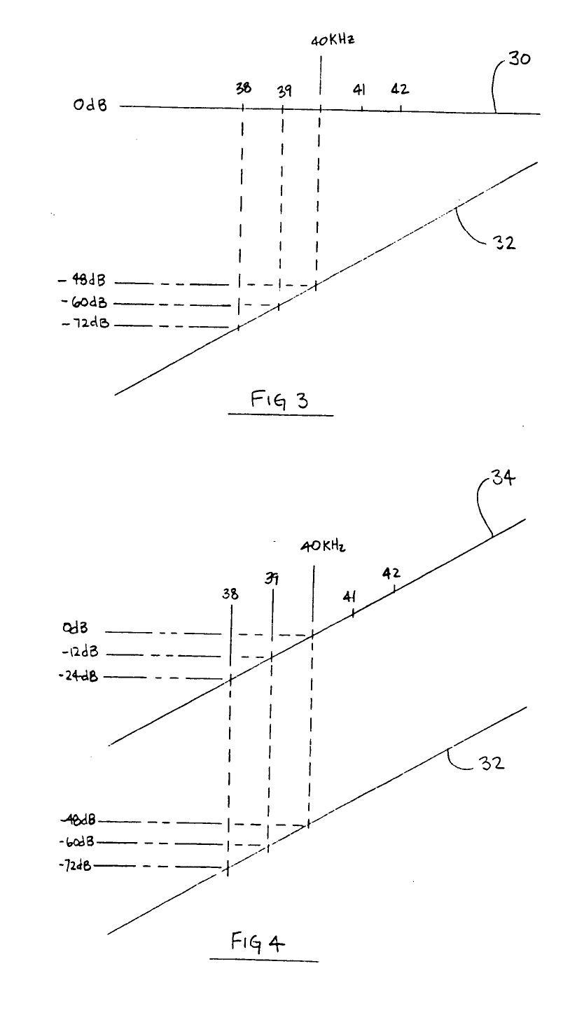

The decline in efficiency of the emitter below the fundamental resonance frequency generates surprising results in an LSB system. FIG. 3 shows the response of a hypothetical emitter with a flat frequency response 30 below resonance. The parametric conversion process generates a 12 dB per octave roll off 32 with descending LSB ultrasonic frequencies. A 40 kHz carrier frequency modulated with two LSB frequencies, 38 kHz and 39 kHz, will generate 1 kHz and 2 kHz difference tones in the audio. Because the frequency response of the emitter is flat and the parametric conversion causes a 12 dB per octave roll off, the 1 kHz and 2 kHz difference tones will be 12 dB apart in intensity.

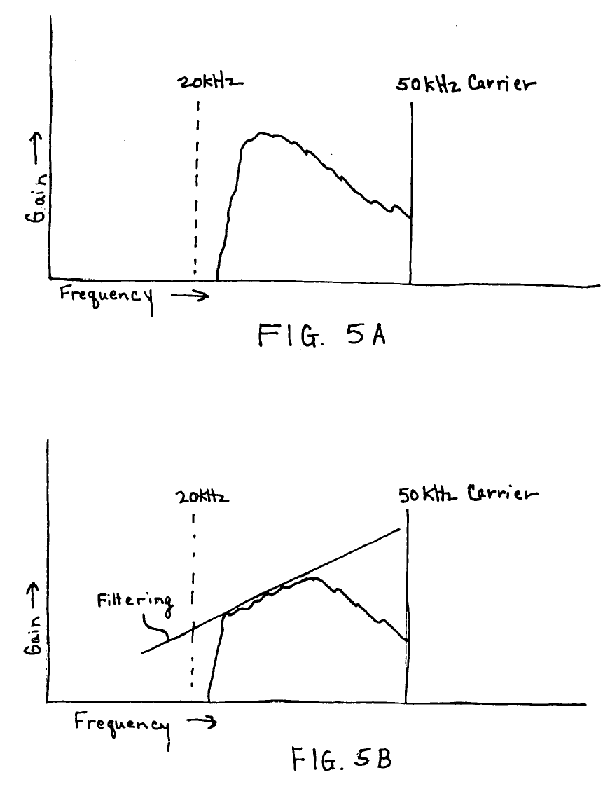

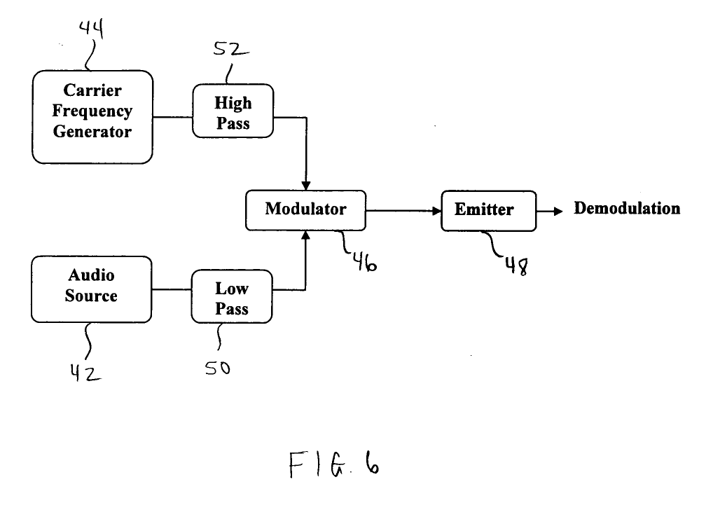

By using an emitter with a frequency response that also falls at 12 dB per octave (34 FIG. 4), the cumulative effect of the emitter roll-off and the parametric attenuation is an even steeper filtering of the inverted higher tones. This advantageous self equalization or filtering causes the parametric loudspeaker system to more effectively approach a flat amplitude characteristic, due to the similar high pass roll off characteristics between the output of the emitter and the parametric conversion process. These high pass characteristics also serve to attenuate the ultrasonic frequencies that enter the audible range, thus reducing distortion. FIG. 5a and FIG. 5b illustrate the filtering of an inverted signal.

Even greater high pass attenuation can be achieved by applying a high pass filter to the modulated signal, and a low pass filter to the audio signal. This causes a greater separation of the audio and the ultrasound frequencies, thus decreasing distortion from the higher frequency output as it approaches the range of high frequency audibility. For example, to maximize stop band slopes, low pass filtering can be done in the audio up to about 20 kHz then high pass filtering should be implemented in the ultrasonic system below about 20 kHz.

A further advantage of the present invention is that the parametric loudspeaker system has an increased directivity because the higher frequency program signal that is inverted into lower frequencies below the carrier signal are filtered. This directivity tends to exist because higher frequencies are more directive than low frequency output.

In one embodiment of the invention, the input side of the parametric loudspeaker system accepts a line-level signal from an analog or digital audio source such as a CD player. In the digital implementation, an analog audio signal will first be digitized or a direct digital input may be received. As shown in FIG. 6, an incoming audio signal from the audio source 42 is modulated with a higher ultrasonic carrier frequency to create a modulated signal. The carrier signal is generated by a carrier frequency generator 44 set at the desired frequency. Note that in a multi-channel system (stereo, for example), just one generator may be used so that all channels have exactly the same carrier frequency. The desired frequency may be set at or slightly above the fundamental resonance frequency of the emitter to increase output efficiency and maximize the self equalization or filtering properties of the system. The modulation signal is filtered such that primarily LSB signals are present with the carrier. The modulation occurs electronically via a modulator 46, following which the modulated signal is transferred through an emitter 48 to the air column and demodulation occurs. The audio signal may optionally be low pass filtered 50 or the carrier frequency generator 52 may be high pass filtered.

The emitter has a falling high pass characteristic of at least 12 dB per octave. For under damped systems, the falling high pass characteristic is much greater than 12 dB per octave in the region of the fundamental resonance frequency of the emitter. Because of the inverted nature of the LSBs, this high pass characteristic causes the demodulated audio output to be low pass filtered, thus increasing the lower audio frequency pass band or stop band pass where the majority of the peak energy factors of the program material are. So in a 20 kHz bandwidth, the sideband information that is displaced 20 kHz from the carrier will be relatively low. If a 40 kHz carrier is used, the spectral content of the program material may provide relatively low output at all frequencies below 38 kHz, with the spectrum falling between 3 and 6 dB per octave, of transducer rolloff depending on the program type. Combined with the parametric conversion roll off of 12 dB per octave with descending LSB ultrasonic, this can result in at least a 15 dB per octave “audio” attenuation, which translates to more than 90 dB per octave from 40 kHz down to 20 kHz in the ultrasonic. This assumes a 300 Hz to 20 kHz audio bandwidth.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth in the claims. The following paragraphs are example embodiments of the present invention.

1. A parametric loudspeaker system, comprising:
a carrier frequency generator to produce a carrier frequency;
a modulator that receives an audio signal and modulates the audio signal onto the carrier frequency to produce a modulated signal;
a sideband frequency divergent from the carrier frequency by a frequency value of the audio signal; and
wherein the sideband frequency operates at frequencies lower than the carrier frequency.

2. A parametric loudspeaker in claim 1, further comprising:
an electro-acoustic emitter having a resonant frequency; and
the carrier frequency operating at a frequency corresponding to the resonant frequency of the electro-acoustic emitter.

3. A parametric loudspeaker as in claim 2, wherein a majority of sideband frequencies are at frequencies below the resonant frequency of the electro-acoustic emitter.

4. A parametric loudspeaker as in claim 2, wherein the resonant frequency of the electro-acoustic emitter is the fundamental resonant frequency of the electro-acoustic emitter.

5. A parametric loudspeaker as in claim 2, wherein:
the electro-acoustic emitter has a falling high pass characteristic of at least 12 dB per octave for an inverted lower sideband signal; and
wherein the high pass characteristic creates an acoustic equalization at least partially compensating for a falling parametric high pass characteristic of substantially more than 12 dB per octave.

6. A parametric loudspeaker as in claim 5, wherein the falling high pass characteristic of the emitter is greater than 12 dB per octave in the region of the fundamental resonant frequency such that the high pass characteristic causes an inverted equalization characteristic that equalizes the falling parametric high pass characteristic to more effectively approach a flat amplitude characteristic than would a transmitter that has a 12 dB per octave falling high pass characteristic.

7. A parametric loudspeaker as in claim 5, wherein a falling high pass characteristic below the resonant frequency of the transducer causes a low pass characteristic applied to the converted acoustic output increasing lower audio frequency pass band, which reduces the falling high pass characteristic of the falling parametric high pass characteristic to less than 12 dB per octave over a substantial portion of the audio signal's frequency range.

8. A parametric loudspeaker as in claim 1, wherein:
the audio signal has a low pass filter applied to the audio signal; and
the modulated signal has a high pass filter applied to the modulate signal;
wherein the low pass filter and the high pass filter, working in conjunction, form a greater high pass attenuation than the high pass filter applied to the modulated signal in an ultrasonic frequency range that approaches a range of high frequency audibility.

9. A parametric loudspeaker as in claim 8, wherein:
the low pass filter is applied to the audio signal up to about 20 kHz; and
the high pass filter is applied to the modulated signal below about 20 kHz.

10. A parametric loudspeaker system, comprising:
a carrier frequency generator to produce a carrier frequency;
a modulator that receives an audio signal and modulates the audio signal onto the carrier frequency to produce a modulated signal;
a sideband frequency divergent from the carrier frequency by the frequency value of the audio signal; and
wherein the sideband frequency is generated such that sideband frequencies associated with higher audio input frequencies are at frequencies associated with lower acoustic saturation in air than sideband frequencies associated with lower audio input frequencies.

11. A parametric loudspeaker system, comprising:
a carrier frequency generator to produce a carrier frequency;
a modulator that receives an audio signal and modulates the audio signal onto the carrier frequency to produce a modulated signal;
a sideband frequency divergent from the carrier frequency by the frequency value of the audio signal; and
a lower frequency sideband closer to a high frequency audible range than a higher frequency sideband, is on average a lower amplitude signal level than all relatively higher frequency sideband frequencies.

12. A parametric loudspeaker system as in claim 11, wherein a carrier frequency placed at a maximum efficiency portion of an emitter's operating range with sidebands being produced in a constantly falling amplitude range of an emitter's operating range.

13. A parametric loudspeaker system as in claim 11, wherein an emitter has a smoothly falling amplitude response below a fundamental resonant frequency and an erratic or secondary resonance response above the fundamental resonant frequency, wherein the sidebands are emitted in the smoothly progressing amplitude response range of the emitter.
